(19) United States
(12) Patent Application Publication
(10) Pub. No.: US 2015/0215583 A1
(43) Pub. Date: Jul. 30, 2015

(54) Cloud Video Surveillance

(71) Applicant: Rasilient Systems, Inc., Santa Clara, CA (US)

(72) Inventor: Yee-Hsiang Sean Chang, Cupertino, CA (US)

(21) Appl. No.: 14/561,181

(22) Filed: Dec. 4, 2014

Related U.S. Application Data
(60) Provisional application No. 61/911,808, filed on Dec. 4, 2013.
(60) Provisional application No. 61/911,817, filed on Dec. 4, 2013.

(51) Int. Cl. H04N 7/18; G08B 13/196

(52) U.S. Cl. CPC H04N 7/181; G08B 13/19645; G08B 13/19656

(57) ABSTRACT

A video surveillance system comprises internet protocol (“IP”) cameras; a network; and cloud computing resources having a management resource, a video storage resource, and a viewing and control resource. The IP cameras and cloud computing resources are connected via the network. The IP cameras independently access each of the cloud computing resources. An application software of a device connected to the network identifies one or more objects of interest from the video data of the IP cameras for extraction.

### CROSS REFERENCES

This application claims priority from a provisional patent application entitled “Methods to Provide Cloud Video Surveillance” filed on Dec. 4, 2013 and having an Application No. 61/911,808 and from a provisional patent application entitled “Methods to Extract Intelligence from Surveillance Video” filed on Dec. 4, 2013 and having an Application No. 61/911,817. Said applications are incorporated herein by reference.

### FIELD OF INVENTION

The disclosure relates to video surveillance, and, more particularly, to methods and systems for video surveillance using cloud networking resources.

### BACKGROUND

Video surveillance is transitioning from analog cameras to internet protocol (“IP”) cameras. For instance in 2013, 50% of North American deployments used IP cameras. The percentage of IP camera deployments is lower worldwide, but is quickly accelerating.

A typical analog video surveillance system connects analog cameras from various locations to a centralized station using coaxial cables. The central station is where security guards view live video feeds from the analog cameras. The security guards monitor all the analog cameras and can respond to any events accordingly. In the central station, digital video recorders (“DVRs”) are used to convert the analog signal of the live video feed to a digital signal for displaying and recording of the video feed.

For IP cameras, instead of using coaxial cables for transporting analog signals to the central station, the IP cameras use prevalent internet and/or ethernet technologies to connect the IP cameras to the central station. The IP cameras encode the live video feed before sending the live video feed across one or more networks to the central station. Since the distance to the central station is not limited by any hardwired coaxial cables, the central station can be much farther away than in an analog camera architecture and can use state-of-the-art computers to view, control, record, and manage the video feeds.

IP cameras can simplify large scale video surveillance deployment for various reasons. First, the IP cameras can be located anywhere that is connected to the internet. Second, the network video recorder (“NVR”) is decoupled from the length limitation of coaxial cables. The IP cameras provide a hierarchical network structure for multi-level viewing, recording, and management. Third, the NVR uses the state-of-the-art computers and display technologies to build up a high resolution video wall (where the video wall is essentially a wall of display devices displaying multiple video feeds side-by-side) to view a large area monitored by the IP cameras connected to the NVR.

Many current city-wide video surveillance systems are implemented using the IP camera-NVR architecture. In total, tens of millions of surveillance cameras are operational that are either hardwired or otherwise connected via an IP network connection to NVRs. Significant problems occur due to the great number of surveillance cameras connected to the NVRs. First, each of the NVRs can only be connected to a maximum number of IP cameras. Second, the resources of the NVRs must be carefully provisioned, or the NVRs may experience dropped video data, increased latency, and other delays caused by overloading. A number of servers running NVR software, or video management software (“VMS”) can also run video analytic software applications such as license plate recognition software and/or other video analytics software. An external storage can be connected to the NVRs via a SAN. The VMS manages the data from hundreds to thousands of cameras. Behind the servers, the IP SAN is used to store all the data.

The IP camera/NVR architecture basically uses the same hierarchal structure as an analog camera/DVR architecture. In particular, the focal point of the respective system is the security stations, where the guards view, control, manage, and record the surveillance video. The IP camera/NVR architecture places the highest priority on the viewing function, so that security guards can see what is happening. The viewing function dictates the video quality of the respective system. Other functions, such as recording, control, management, etc. are secondary concerns and are built around the viewing function.

To support the viewing quality, each video stream is provisioned from the camera, through a particular switch port, to a specific server, and finally recorded to a specific storage volume to make sure the desired frame rate and resolution requirements are met. A server needs to be carefully provisioned to prevent overloading of its central processing unit and respective video card, else the information from the IP cameras would overwhelm the server.

Any component failures (e.g., camera, switch port, server, storage volume, etc.) will cause problems. To meet 24×7 requirements in many environments, the surveillance industry offers enterprise level solutions to make sure each component is robust and has automatic fail safe procedures in place. However, such enterprise level surveillance solutions are costly. Even with enterprise level surveillance solutions, its resources may be temporarily overloaded which would cause video frame drops. For instance, any software applications (“apps”) for video analytics or otherwise, apps updates, and VMS updates could potentially overload the surveillance system. Thus, engineering efforts are needed to check for adequate end-to-end resources. The resource provisioning becomes critical to make sure all software applications are within provisioning limits for the NVR to work properly.

FIG. 1 illustrates a block diagram of a prior art video surveillance system. The video surveillance system comprises IP cameras 20, a network switch 22, an NVR 24, a display 26, and video storages 28. The network switch 22 connects the IP cameras 20 and the NVR 24. This IP camera architecture maintains the same hierarchal structure used in analog camera systems. The focal point of the respective system is for viewing at security stations, where security guards can view, control, manage, and record the surveillance video by operating the NVR 24. In such architecture, the viewing of the video data on the display 26 has the highest priority for viewing by the security guards. The viewing dictates the video quality requirement. The rest of the functions like recording, control, and management are built around viewing. For example, the video is recorded after viewed.

To support the viewing quality, each video stream is provisioned from the IP cameras 20 through the network switch 22 to the NVR 24. The NVR 24 can further record any video stream to the video storages 28, where the recording has a desired frame rate and resolution. The NVR 24 needs to be carefully provisioned by its respective central processing unit (“CPU”) and video card to make sure that the number of IP cameras 20 does not overwhelm its resources. Any resource constraints, even temporarily, would cause quality degradation such as dropped video frames. This is a known industry problem that the NVR 24 would drop frames.

For instance, if more IP cameras are added to the IP cameras 20, then additional resources must be manually added to the NVR 24 to account for the additional end-to-end resources needed by the additional IP cameras. Furthermore, the NVR 24 can run apps, e.g., license plate recognition software and other video analytics software. The resource provisioning for the NVR 24 becomes critical to make sure there is enough computing resources to carry out the analytics. Any new apps, app updates, or VMS updates would potentially cause the NVR 24 to overload and ultimately malfunction.

FIG. 2 illustrates a block diagram in which various software applications can be connected to an IP SAN 12. The IP SAN can route the apps 10 to video storages 14 for storing and retrieving video data to or from the video storages 14. Due to the vast number of cameras and amount of video data that may be recorded on the video storages 14, a vast amount of video data may not viewed or scanned at all by the apps 10. Furthermore, there is no useful way to search or organize the video data in the video storages 14 for easy reference or use by the software applications 10.

Currently, surveillance systems have no way to extract useful information from video data. Scanning the recorded video from the outside world is almost impossible since the recorded video is difficult to access and since each NVR is an island in itself. Any video analytics must be performed in real-time as the video is viewed and/or recorded, further stressing the surveillance system resources that can lead to frame drops and lag. If real time analytics are not operational or not performed correctly, then there is no way to scan for specific objects without having to rescan all the recorded data.

Therefore, for at least the above reasons. There is a need for new methods, apparatuses, and systems for video surveillance that is scalable to handle a vast number of IP cameras. Furthermore, there is a need for new methods, apparatuses, and systems for video surveillance that can extract intelligence from a surveillance video.

### SUMMARY OF INVENTION

Briefly, the disclosure relates to a video surveillance system, comprising: internet protocol (“IP”) cameras; a network; and cloud computing resources having a management resource, a video storage resource, and a viewing and control resource, wherein the IP cameras and cloud computing resources are connected via the network, and wherein the IP cameras independently access each of the cloud computing resources.

### DESCRIPTION OF THE DRAWINGS

The foregoing and other aspects of the disclosure can be better understood from the following detailed description of the embodiments when taken in conjunction with the accompanying drawings.

FIG. 1 illustrates a block diagram of a prior art video surveillance system.

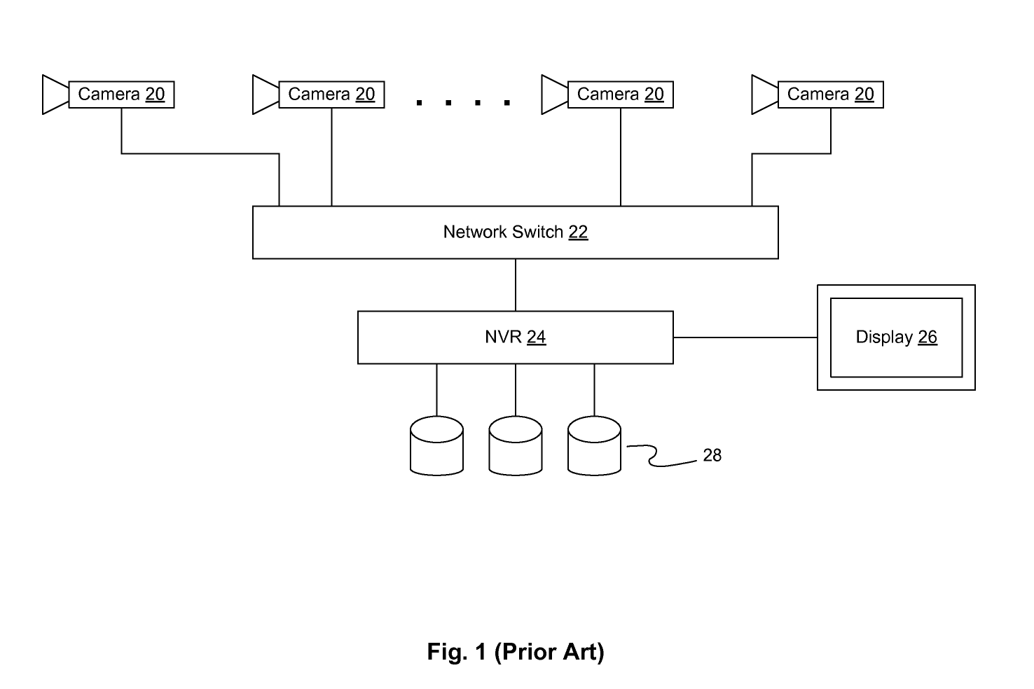

FIG. 2 illustrates a block diagram of a prior art video surveillance system for retrieving video data from a storage area network.

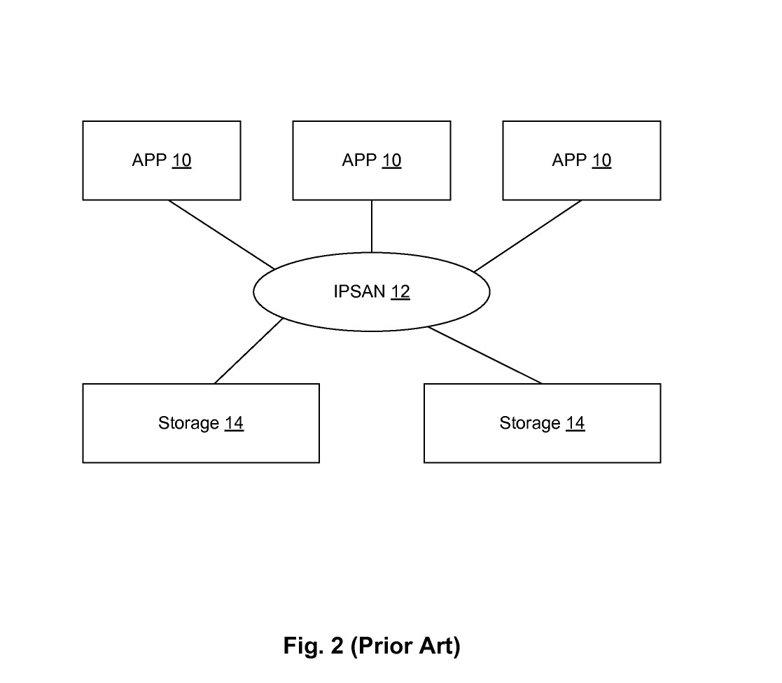

FIG. 3 illustrates a video surveillance system of the present disclosure.

FIG. 4 illustrates another embodiment of a video surveillance system of the present disclosure.

FIG. 5 illustrates a block diagram for initializing a surveillance camera of the present disclosure.

FIG. 6 illustrates a block diagram for selecting objects to locate and record using a surveillance camera of the present disclosure.

FIG. 7 illustrates a surveillance system of the present disclosure monitoring a geographical area.

### DETAILED DESCRIPTION OF THE EMBODIMENTS

In the following detailed description of the embodiments, reference is made to the accompanying drawings, which form a part hereof, and in which is shown by way of illustration of specific embodiments in which the disclosure may be practiced.

Cloud resources are supported by data centers with a concentration of information technology (“IT”) resources for computing, storage, and interconnection. An important cloud concept is the assumption that an interconnection something can fail without losing access to the IT resources and services. This is due to the fact that a cloud subsystem is extremely scalable. This assumption leads to various cloud technologies, which can remove end-to-end provisioning requirements. In other words, data does not need to travel through a specific path, specific switch port, specific server, or to a specific volume of a storage device.

In a cloud subsystem, the data can go through any path and be stored in multiple places. Similarly, resource provisioning can be performed in a global fashion. For instance, additional IP cameras can be added without having to first check if any provisioning limits have been surpassed on the storage, management, or viewing side.

A cloud subsystem can be incorporated in a surveillance system of the present disclosure by allowing separation of viewing/controlling, recording, and management resources for the respective video surveillance system. In other words, a viewing function of the surveillance system does not have to be the first priority, and every other function a secondary priority. Each function of the surveillance system can operate independently and can be managed at different locations and by different personnel. Thus, a quality of service dictated by the viewing may not apply to recording, and vice versa, giving administrators and users of the respective surveillance system greater flexibility.

The surveillance system of the present disclosure can also comprise IP cameras that can have video data stored in a local (or remote) cache and transferred to a video storage resource. The local cache can be a flash card on the camera or other memory local to the camera. Thus, the camera of the present disclosure may not need to follow any provisioning requirements for the video quality, as would be required in an IP camera/NVR architecture. Rather, in the present disclosure, a full resolution and a frame rate of a video feed from a camera can be maintained for the camera of the surveillance system of the present disclosure.

Camera management can also be provided using a surveillance system of the present invention. Once the management is done “out-of-band”, e.g., using a cloud sub-system, it can be scalable. Using the cloud subsystem, dedicated staff can manage a large number of IP cameras simultaneously. The staff can transfer its focus from viewing the cameras to a new focus of whether an IP camera is active, properly configured, has the right firmware version, is generating data, was reset, and so on and so forth. The IP camera can be remotely managed as an internet-connected device.

In a surveillance system of the present disclosure, video analytics can be computed using cloud computing resources to scan through the video data (rather than being entirely performed by a single NVR). Provisioning requirements are greatly reduced (to eliminated) since the cloud computing resources are scalable to fit the needs of the video analytics. By separating recording and management resources, both recording and management resources can use their own individual protocols to improve efficiency and robustness. This is a significant difference from an IP camera/NVR architecture in which all the system resources are tied to the NVR using the IP camera's standard streaming protocol.

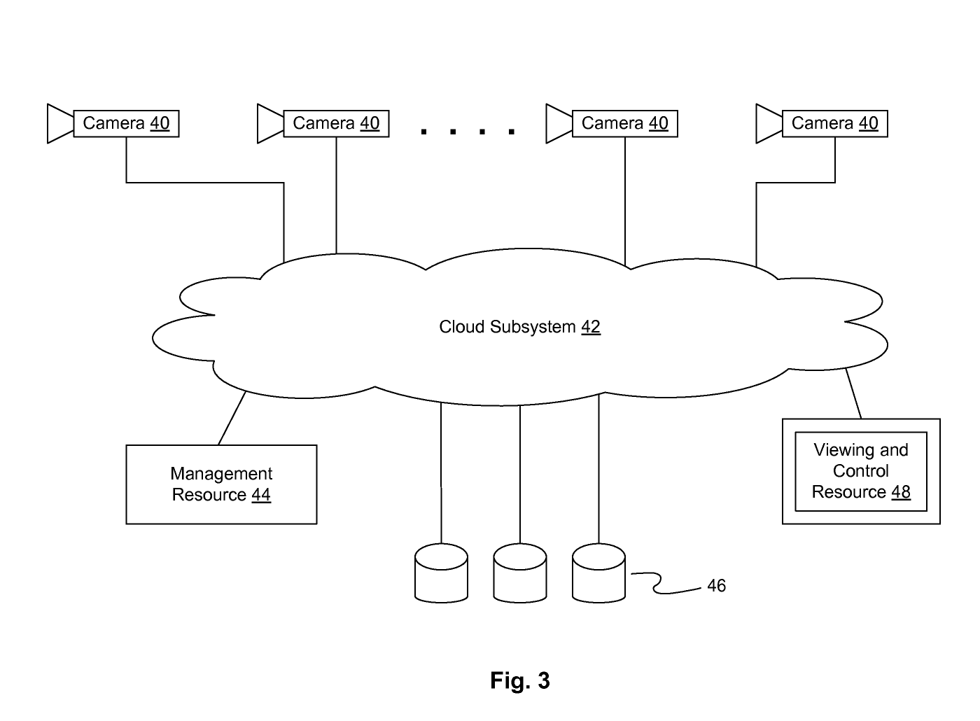

FIG. 3 illustrates an embodiment of a video surveillance system of the present disclosure. A video surveillance system comprises IP cameras 40 and a cloud subsystem 42, where the cloud subsystem 42 is connected to cloud resources, including a management resource 44, a video storage resource 46, and a viewing and control resource 48. The cloud subsystem 42 can be implemented by a network, e.g., internet, ethernet, local area network, or other computer network. The IP cameras 40 can be wired or wirelessly connected to the one or more cloud resources, including the management resource 44, the video storage resource 46, and the viewing and control resource, 48 via the cloud subsystem 42.

The cloud subsystem 42 provides multiple communication paths from one point of the cloud subsystem 42 to another point of the subsystem 42. The cloud subsystem 42, much like the internet, has fail safes to account for any communication paths that are down or otherwise nonresponsive. Delivery of video data from one point to another point of the cloud subsystem 42 can take various paths through the cloud subsystem 42. Furthermore, the cloud resources, including the management resource 44, the video storage resource 46, and the viewing and control resource 48 can each be implemented by one or more servers connected to the cloud subsystem 42. If one of the servers for a cloud resource is not functional for any amount of time, that cloud resource can be provided by another server(s) connected to the cloud subsystem 42.

The management resource 44 can manage the operation of the IP cameras 40, the video storage resource 46, and the viewing and control resource 48. Commands, software updates, and other electronic data can be communicated from the management resource 44 to the IP cameras 40, the video storage resource 46, and the viewing and control resource 48 via the cloud subsystem 42.

The video storage resource 46 can store video data from the IP cameras 40 via the cloud subsystem 42 and can provide recorded video data to any querying devices, e.g., the management resource 44, the viewing and control resource 48, or any devices connected to the cloud subsystem 42. The video storage resource 46 (or one of the other cloud resources) may also store an index of objects of interest that are located within recorded video data of the IP cameras 40. Within that index, the respective video data location in the video storage resource 46 can be identified and associated with that index for easy retrieval. A remote device (mobile device, a control station, etc.) can access that index to retrieve the video from the respective video data location.

The viewing and control resource 48 can be a video wall of display screens with a control interface, a single display screen, a mobile device (e.g., a laptop, a cellular smart phone, a computing tablet, a monitoring device, a smart watch, etc.), and/or any other display device with control interfaces. Video data can be streamed to the viewing and control resource 48 directly from one or more of the IP cameras 40 via the cloud subsystem 42. Alternatively, recorded video data can be received from the video storage resource 46 to the viewing and control resource 48. If the viewing and control resource 48 is implemented by one or more displays devices, the display devices can be located at the same location or different locations since the cloud subsystem is not confined by any geographical limitations.

IP cameras 40 can independently access each of the cloud computing resources. For instance, video data can be simultaneously transmitted to the video storage resource 46 and the viewing and control resource 48. The video data may travel a first communications path to the video storage resource 46, and also travel a second communications path to the viewing and control resource 48. Since the video storage resource 46 and the viewing and control resource 48 are implemented by different servers, the first communications path and the second communications path are distinct communications paths.

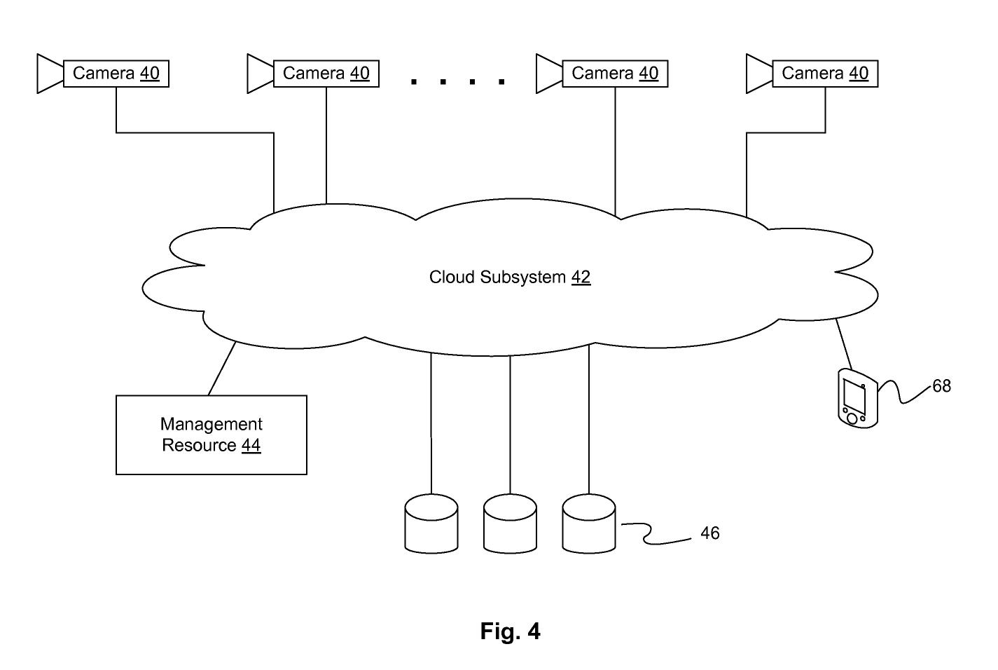

FIG. 4 illustrates another embodiment of a video surveillance system of the present disclosure. In another embodiment, a mobile device 68 can access, view, control, manage, and/or operate certain ones of the IP cameras 40. The mobile device 68 can also access and operate the management resource 44 and/or the video storage resource 46 if the mobile device 68 has the appropriate security rights for such actions. The mobile device 68 allows for degrees of freedom with accessing the certain ones of the IP cameras 40 since the mobile device 68 can be located nearly anywhere, as long as the mobile device 68 has a connection to the cloud subsystem 42.

Additionally, the mobile device 68 may have specialized apps that can select specific objects of interest to scan for in the live video feeds from the IP cameras 40 and/or from the recorded video data stored in the video storage resource 46. Once video data having those objects of the interest are located, the respective video can be transmitted to the mobile device 68 or recorded in the video storage resource 46.

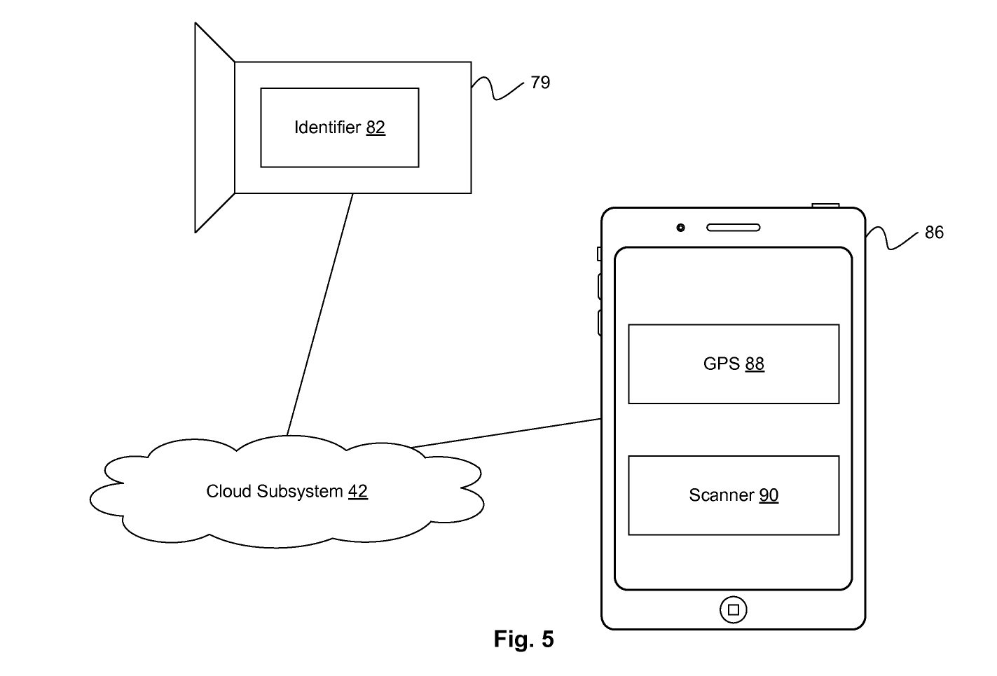

FIG. 5 illustrates a block diagram for deployment of a surveillance camera of the present disclosure. A surveillance camera 79 of the present disclosure can be deployed at a geographical location by simply connecting the surveillance camera 79 to the cloud subsystem 42. The location itself can be identified by scanning a unique identifier 82 (e.g., a predefined alphanumeric code, a QR code, a bar code, a radio frequency identification, etc.) by another device, e.g., a mobile device 86. The mobile device 86 can have a scanner 90 to read the unique identifier 82 and a global positioning system (“GPS”) 88. The scanned identifier 82 and the current location of the mobile device 86 as determined by the GPS 88 can be uploaded to a management resource or other cloud resource via the cloud subsystem 42 for tracking and management purposes of the camera 79. If the mobile device 86 has internet connectivity or other wireless data connectivity, that information is immediately uploaded, otherwise that information can be uploaded to the management resource 44 at another time.

In other embodiments, a surveillance camera of the present disclosure can further comprise a GPS (not shown). When the surveillance camera is connected with the cloud subsystem, its unique identifier of the camera and the GPS location can be automatically uploaded to the management resource 44 or other cloud resource for tracking and management.

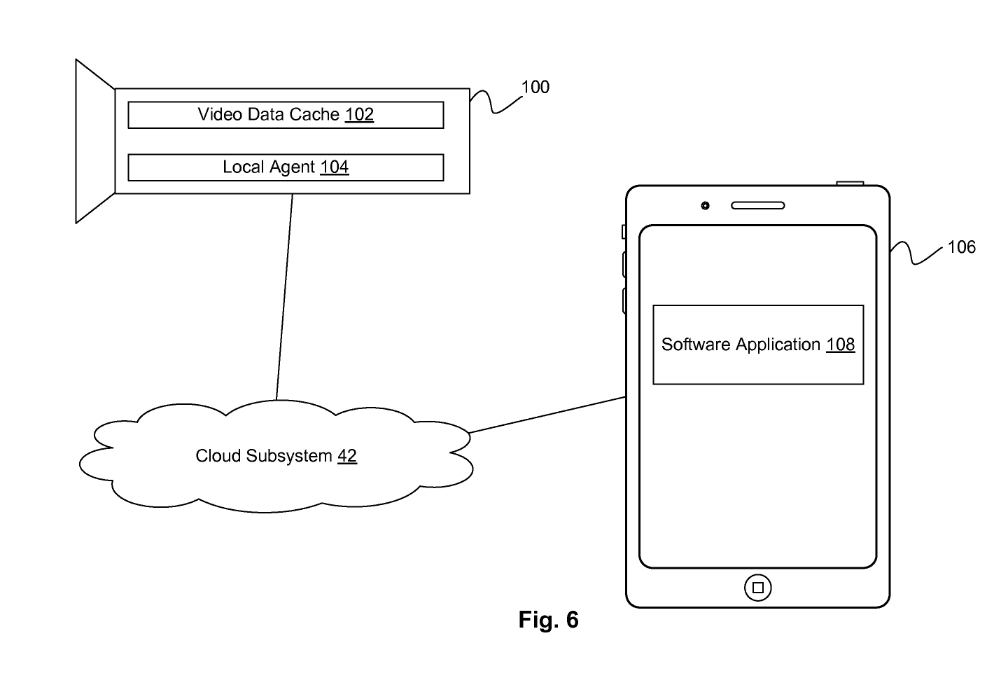

FIG. 6 illustrates a block diagram for selecting objects of interest to locate and record using a surveillance camera of the present disclosure. A camera 100 of the present disclosure can have a video data cache 102 and a local agent 104 for running software application(s) to search for objects of interest. If any objects of interest are located, the current video feed can be stored in the video data cache 102. The recorded video data can be uploaded to the cloud subsystem 42 for further storage at the video storage resource 46 or to a device connected to the cloud subsystem for viewing.

A mobile device 106 can have a software application 108 for selecting objects of interest. The software application 108 can upload selected objects of interest to the cloud subsystem 42 for searching recorded video data and current video feeds connected to the cloud subsystem 42 for the selected objects of interest. Once any video data is found having the selected objects of interest, that video data can be delivered to the mobile device 106 for viewing or further storage.

In particular, the camera 100 can run the local agent 104 to scan for the selected objects of interest. If any video captured by the camera 100 contains the selected objects of interest, the local agent 104 of the camera 100 can store that video data into the video data cache 102. The video data cache 102 can then be uploaded via the cloud subsystem 42 for recording by the video storage resource 46. Thus, the agent 104 can extract real-time video information as the objects are identified in a current video feed of the camera 100 to lessen or eliminate any cloud computing power to process recorded video for the objects of interest. The current video feed having the identified objects of interest can also be immediately uploaded to the cloud subsystem 42. Other information can be selected for the camera 100 to scan for as well, including whether or not an alarm was motion triggered, facial recognition, license plate recognition, date of the video, size of the video, GPS location of the video/camera, compression used, frame rate used, resolution used, predefined triggers, and so on and so forth.

Once the video objects are recorded into the cloud subsystem 42, apps can scan the recorded video one or more times for generating further analytics regarding the recorded video. With each scan, new information can be ascertained from the recorded video and indexed by the cloud resources so software applications can make queries for the new information and quickly find video data that has such information. Using cloud resources, computing power used to extract intelligence from video data is no longer a limiting factor.

Software applications connected to the cloud subsystem 42 can communicate with the camera 100's local agent to request the capture of real-time video for select objects and triggers. The software applications can send requests to the camera's local agent for specific captures (e.g., a specific license plate number). This enables cameras to capture specific items in real-time. Both a front-end camera and a back-end cloud subsystem can input video intelligence, and work together for applying specific actions and functionality. With the information collected for each video object in a cloud database, meaningful reports can be delivered to various users, including a property owner, a security director, a guard, a police officer, etc.

The IP camera can extract video intelligence for each video object and store that respective video having the video object in a cloud database. An application programming interface (“API”) allows for video analytic software applications to operate on the respective video and video objects via the cloud subsystem. The cloud video analytic applications can extract video intelligence from the video, and have that information stored in a cloud database or resource for users and other applications to use. The analytic applications can further prioritize the video information, so that a user is only shown important events from the video feeds.

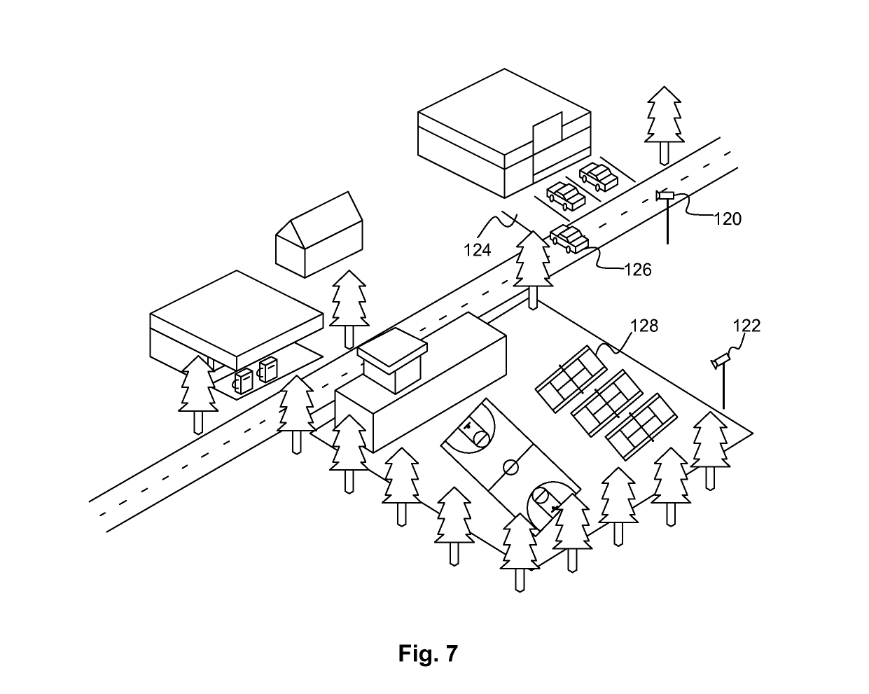

FIG. 7 illustrates a diagram for deployment of IP cameras of the present disclosure. A street having a parking space 124 can be monitored by one or more IP cameras, including camera 120 and 122. The cameras 120 and 122 have local agents running on the camera to identify certain actions, triggers, objects of interest, and combinations thereof, including whether or not a certain object of interest is within the current live video feed of the camera, whether or not a certain person or thing has left a certain area, number of people at certain area, and other information.

For instance, the camera 120 can have a local agent running on it to detect the amount of time and when the parking space 124 is taken or not taken. Video feed of when the parking space is taken can be recorded locally to the camera 120 or further uploaded to the cloud subsystem for further storage and/or notification of such an event. As an example, the camera 120 may have record a car 126 parking into the parking space 124 into its local cache. Furthermore, the camera 122 can monitor the number of people in the tennis courts 128 or in the area of the tennis courts, and transmit such information to the cloud subsystem.

While the disclosure has been described with reference to certain embodiments, it is to be understood that the disclosure is not limited to such embodiments. Rather, the disclosure should be understood and construed in its broadest meaning, as reflected by the following claims. Thus, these claims are to be understood as incorporating not only the apparatuses, methods, and systems described herein, but all those other and further alterations and modifications as would be apparent to those of ordinary skilled in the art.

We claim:

1. A video surveillance system, comprising:
internet protocol (“IP”) cameras;
a network; and
cloud computing resources having a management resource, a video storage resource, and a viewing and control resource,
wherein the IP cameras and cloud computing resources are connected via the network, and
wherein the IP cameras independently access each of the cloud computing resources.

2. The video surveillance system of claim 1 wherein video data is simultaneously transmitted to the video storage resource and the viewing and control resource.

3. The video surveillance system of claim 2 wherein the video data travels a first communications path to the video storage resource, wherein the video data travels a second communications path to the viewing and control resource, and wherein the first communications path and the second communications path are distinct communications paths.

4. The video surveillance system of claim 1 wherein a certain one of the IP cameras having a unique identifier is installed at a location, wherein a mobile device having a global positioning system scans the unique identifier of the certain one of the IP cameras, and wherein the mobile device uploads information relating to the location and the unique identifier of the certain one of the IP cameras to the management resource via the network.

5. The video surveillance system of claim 1 wherein a certain one of the IP cameras is installed at a location, wherein the certain one of the IP cameras has a global positioning system and a unique identifier, and wherein the certain one of the IP cameras uploads information relating to the location and the unique identifier to the management resource via the network.

6. The video surveillance system of claim 1 wherein the management resource is implemented by a first set of servers, the video storage resource is implemented by a second set of servers, and the viewing and control resource is implemented by a third set of servers.

7. The video surveillance system of claim 1 further comprising a mobile device, wherein the mobile device runs an application software for selecting one or more objects of interest, wherein the IP cameras are instructed by the application software to search for the selected one or more objects of interest.

8. The video surveillance system of claim 7 wherein a certain one of the IP cameras identifies the selected one or more objects of interest in a respective video feed, and wherein the respective video feed having the selected one or more objects of interest is locally cached in the certain one of the IP cameras.

9. The video surveillance system of claim 8 wherein the cached video feed is transmitted to the video storage resource and wherein the mobile device can access the video storage resource to view the recorded video feed having the selected one or more objects of interest.

10. The video surveillance system of claim 7 wherein an index is generated for the selected one or more objects of interest recorded in the video storage resource, and wherein a remote device accesses the index via the network.

11. A video surveillance system, comprising:
internet protocol (“IP”) cameras;
a network; and
cloud computing resources having a management resource, a video storage resource, and a viewing and control resource,
wherein the IP cameras and cloud computing resources are connected via the network,
wherein the IP cameras independently access each of the cloud computing resources,
wherein video data is simultaneously transmitted to the video storage resource and the viewing and control resource,
wherein the video data travels a first communications path to the video storage resource,
wherein the video data travels a second communications path to the viewing and control resource, and
wherein the first communications path and the second communications path are distinct communications paths.

12. The video surveillance system of claim 11 wherein a certain one of the IP cameras having a unique identifier is installed at a location, wherein a mobile device having a global positioning system scans the unique identifier of the certain one of the IP cameras, and wherein the mobile device uploads information relating to the location and the unique identifier of the certain one of the IP cameras to the management resource via the network.

13. The video surveillance system of claim 11 wherein a certain one of the IP cameras is installed at a location, wherein the certain one of the IP cameras has a global positioning system and a unique identifier, and wherein the certain one of the IP cameras uploads information relating to the location and the unique identifier to the management resource via the network.

14. The video surveillance system of claim 11 wherein the management resource is implemented by a first set of servers, the video storage resource is implemented by a second set of servers, and the viewing and control resource is implemented by a third set of servers.

15. The video surveillance system of claim 11 further comprising a mobile device, wherein the mobile device runs an application software for selecting one or more objects of interest, wherein the IP cameras are instructed by the application software to search for the selected one or more objects of interest.

16. The video surveillance system of claim 15 wherein a certain one of the IP cameras identifies the selected one or more objects of interest in a respective video feed, and wherein the respective video feed having the selected one or more objects of interest is locally cached in the certain one of the IP cameras.

17. The video surveillance system of claim 16 wherein the cached video feed is transmitted to the video storage resource and wherein the mobile device can access the video storage resource to view the recorded video feed having the selected one or more objects of interest.

18. The video surveillance system of claim 15 wherein an index is generated for the selected one or more objects of interest recorded in the video storage resource, and wherein a remote device accesses the index via the network.

19. A video surveillance system, comprising:
internet protocol (“IP”) cameras;
a network;
cloud computing resources having a management resource, a video storage resource, and a viewing and control resource; and
a mobile device,
wherein the mobile device runs an application software for selecting one or more objects of interest,
wherein the IP cameras are instructed by the application software to search for the selected one or more objects of interest,
wherein the IP cameras and cloud computing resources are connected via the network,
wherein the IP cameras independently access each of the cloud computing resources,
wherein video data is simultaneously transmitted to the video storage resource and the viewing and control resource,
wherein the video data travels a first communications path to the video storage resource,
wherein the video data travels a second communications path to the viewing and control resource,
wherein the first communications path and the second communications path are distinct communications paths, and
wherein the management resource is implemented by a first set of servers, the video storage resource is implemented by a second set of servers, and the viewing and control resource is implemented by a third set of servers.

20. The video surveillance system of claim 19 wherein a certain one of the IP cameras identifies the selected one or more objects of interest in a respective video feed, wherein the respective video feed having the selected one or more objects of interest is locally cached in the certain one of the IP cameras, wherein the cached video feed is transmitted to the video storage resource, wherein the mobile device can access the video storage resource to view the recorded video feed having the selected one or more objects of interest, wherein an index is generated for the selected one or more objects of interest recorded in the video storage resource, and wherein a remote device accesses the index via the network.
